(19) United States
(12) Patent Application Publication
(10) Pub. No.: US 2014/0268440 A1
(43) Pub. Date: Sep. 18, 2014

(54) Micromachined High Breakdown Voltage ESD Protection Device for Light Emitting Diode and Method of Making the Same

(71) Applicants: Chih-Chang Chen, Cupertino, CA (US); Liji Huang, San Jose, CA (US)

(72) Inventors: Chih-Chang Chen, Cupertino, CA (US); Liji Huang, San Jose, CA (US)

(73) Assignee: Wisenstech Inc., Santa Clara, CA (US)

(21) Appl. No.: 13/795,489

(22) Filed: Mar. 12, 2013

(51) Int. Cl. H02H 9/04

(52) U.S. Cl. CPC H02H 9/04
USPC 361/56

(57) ABSTRACT

This invention relates to a micromachined ESD protection device and its microfabrication method for light emitting diode (LEDs) chips. The LEDs is coupled to the ESD protection device in a shunt connection to absorb and eliminate the electrostatic charges induced by human contact or other voltage spike sources. The ESD protection circuit can prevent the LED from burning down and extend its lifespan. By using a thick polyimide layer as the dielectric film for capacitors in the micromachined ESD protection device at the current invention has the advantages with high breakdown voltage compared to other ESD protection circuits. And furthermore, the device in the current invention is easy for mass production with low manufacturing cost. Another embodiment of the present invention is that the multiple-array arrangement in current micromachined ESD protection device could greatly enhance the liability due to multiple-protection and thus to provide the possibility of multiple-times usage.

### BACKGROUND OF THE INVENTION

1. Field of the Invention

This invention relates to a micromachined ESD protection device for light emitting diodes (LED) chips and its micro-fabricating method. The LED chip is coupled with the invented ESD protection device in a shunt connection on a same mounted substrate to absorb and eliminate the electrostatic charges which are induced by voltage spike sources such as human contacts and thus to prevent the LED from burning down and extend its lifespan.

2. Description of the Related Art

In view of the current trend of development, it is fully expected that the brightness of the LED chips will serve as a highly efficient light source in the near future. Due to the superb characteristics of low power consumption, high luminous efficiency and long lifespan of light emitting diodes (LEDs) compared to other conventional light sources, the LEDs lighting for domestic and commercial applications are becoming prevailed and steadily penetrating the lighting market along with the steady declination of its market price. Besides to be as lighting resources, the usage of LEDs lamp as backlights source for liquid crystal displays (LCDs) also becomes popular and even to be a standard feature for high end LCD TVs in the foreseeable future. Because LEDs are very susceptible to the damages caused by electrostatic charges or unexpected large voltage spike, therefore it would be a natural attempt to develop ESD protection for LEDs chips. A reverse bias voltage across the anode and cathode of LEDs will cause great damages to LED chips as well. The ESD voltages in many circumstances could be up to the range of 10,000˜30,000 volts.

One example of a conventional way to provide ESD protection for a LED chip is disclosed in U.S. Pat. No. 5,914,501 taught by William K. Antle et al; wherein the LED chip (14) is coupled with a parallel connection of a set of back-to-back Zener diodes (16a and 16b), as shown in FIG. 1 for modulating voltages entering the LED through the opposing terminals. The back-to-back Zener diodes can clam down the voltage across the terminals of LED chip. However, the Zener diodes is not completely reliable to the ESD and voltage spikes because of its slow response which is coming from the parasitic inductance of the Zener diodes.

Another example of provide ESD protection a LEDs is demonstrated by William David Collins III et al in U.S. Pat. No. 2005/0184387 A1. A metal oxide varistor comprising one or more layers of zinc oxide is formed and integrated to the ceramic substrate to provide ESD protection for the LESs mounted on the same substrate. While the voltage spiking or power surge produced, the varistor's resistance will be rapidly reduced and acting similar to the back-to-back Zener diodes as to provide an instant shunt path for the current generated by voltage spiking or power surge. The breakdown voltage of the varistor is depending on the number of grain-boundaries between top and bottom metal electrodes. More of the grain boundaries will increase the breakdown voltage of the varistor, therefore, for high voltage applications; multi-layers of zinc oxide will become a must to increase the breakdown voltage, which unfortunately will significantly raise the manufacturing complexity and cost.

### SUMMARY OF THE INVENTION

It is therefore an object of the present invention to resolve the above issues of prior conventional arts. The objective of this invention is to provide a high breakdown voltage ESD protection for LEDs, which can prevent the LEDs from burning down and extends their lifespan. The LED chip is engaged to a parallel connection with a RC circuit which is microfabricated by micro-electro-mechanic system (a.k.a. MEMS) technology. Because the breakdown voltage of thin film is equal to the breakdown strength times the thickness of the thin film, therefore, one embodiment of the current invention, is to utilize thick polyimide layer as its dielectric layer between the top and bottom electrodes for the capacitor for the ESD protection device. By deploying this embodiment, the capacitor in current invention, can provide one order higher of breakdown voltage compared to the other type of capacitor due to its great thickness of dielectric layer.

Compared to other common dielectric films in microfabrication technology such as silicon nitride, aluminum oxide, and silicon dioxide etc, polyimide is also one kind of material which is much easier to apply thick layer in a very cost-effective way. Not like the other conventional semiconductor dielectric films which need very expensive tools such as low pressure chemical vapor deposition (LPCVD) or plasma enhance chemical vapor deposition (PECVD), polyimide film can be spin-on coated easily with great thickness. On the other hand, it would be very challenging for silicon nitride, silicon dioxide to deposit a layer with more than 3 um in thickness, wherein the challenges may come from the issues of high stress, uniformity and cost. However it is easy and straightforward technically for polyimide to spin-on coat a layer with thickness in the range of 50 to 100 um. Furthermore, one additional superior advantage of polyimide's characteristics is its low defects structure inside the film compared to other dielectric films. The defects inside the dielectric film can greatly reduce its nominal breakdown voltage. Because the polyimide layer is tending to absorb the moisture from environment and furthermore the moisture inside the polyimide film can lower down its breakdown strength (voltage); therefore a passivation layer of silicon nitride is applied to the ESD protection device to isolate the polyimide from the moisture.

The configuration of the ESD protection device for LED in the present invention is formed by serially connecting two identical capacitors and one resistor in-between the capacitors. The built ESD protection device is then connected with the LED chip in a shunt connection. The symmetrical arrangement of the two capacitors is used to protect the LED chip to the ESD damages from both polarities of current directions.

Another embodiment of the current invention is the array formation built by the single ESD protection device above, which could greatly enhance the ESD protection liability due to multiple-protection and thus to provide the possibility for multiple-times usage of ESD protection device.

### BRIEF DESCRIPTIONS OF THE DRAWINGS

FIG. 1: Illustration of a prior art of an ESD protection device using a set of back-to-back Zener diodes.

FIG. 2: Illustration of a prior art of a prior art of an ESD protection device using zinc oxide varistor.

FIG. 3: Illustration of the schematic of the current preferred embodiment.

FIG. 4: Illustration of the current preferred embodiment of an array with combination of multiple ESD protection devices.

FIG. 5: Illustration of cross section of the capacitor with polyimide as its dielectric film in the current preferred embodiments. A taped profile is crucial to get good step coverage for metal interconnection.

FIG. 6 (a) through FIG. 6 (f) shows a micromachining process to form the ESD protection, device according to the preferred embodiment of the current invention.

### DETAILED DESCRIPTION OF THE PREFERRED EMBODIMENTS

FIG. 1 and FIG. 2 are two prior arts of the ESD protection methods.

FIG. 3 illustrates a schematic of the preferred topology for the current invention. A micromachined ESD protection device is separately fabricated and integrated with the LED chip. The configuration of the ESD protection device comprises two identical capacitors 320 and one resistor 340. The resistor is disposed between the two identical capacitors. The ESD protection device in the current invention is connected to the LED chip 300 in a shunt connection to absorb and eliminate the voltage spike or electro static charges generated from the human contacts. Because the two capacitors are identical, therefore ESD protection device would be symmetrical and functional for the LED chip no matter the voltage spike is coming from which direction.

FIG. 4 shows another preferred embodiment of the current invention. An ESD protection array is formed by connecting three single ESD protection device of the current invention in a shunt connection. The ESD protection array can provide multiple protections even though one of the devices is damaged.

FIG. 5 depicts the cross-section view of the micro-fabricated capacitor of the preferred embodiments in the current invention. The capacitor is utilized thick polyimide film 410 as its dielectric layer between the top 420 and bottom 430 metal electrodes. The breakdown strength of the polyimide is about 200 V/um, therefore for a 50 um thickness of polyimide film, the breakdown voltage can reach to ten thousand volts. On the other hand, for a common dielectric material in microfabrication industry, the breakdown strength of silicon nitride is about 600 V/um. In the case of a challenging and high cost process to deposit 3 um layer of silicon nitride as dielectric layer for the capacitor, the breakdown voltage can only be up to 1800 V which could not provide enough protection for the LED chip as an ESD protection device. In order to attain good step coverage for the top metal electrode 420, the polyimide film needs to form a tapered angle 450 on its edge profile.

The figures of FIG. 6 (a) through FIG. 6 (f) demonstrate the micromachining process for forming the micromachined ESD protection device with high breakdown voltage to the preferred embodiment of the present invention. In FIG. 6 (a), the micromachined ESD protection device is formed first by depositing an insulation layer such as PECVD silicon nitride or silicon dioxide 610 with thickness of 1000 A to 2000 A a substrate 600. And then a first metal conductive layer 620 is deposited by either sputtering or e-beam evaporation method.

In the FIG. 6 (b), the first conductive metal layer 620 is patterned by a first photolithography and an, etch process to form the resistor 660, and bottom electrodes 650 for the first capacitor and the second capacitor.

In the FIG. 6 (c), a thick polyimide layer 680 as a dielectric film between the top and the bottom electrodes for the capacitors is spin-coated; and then a thick layer of photoresist is applied in the second photolithography. After the photolithography process, the thick photoresist will endure a reflow process to form the tapered edge profile and thereafter an oxygen plasma etch is performed to pattern the polyimide layer.

And in the FIG. 6 (d), it depicts that a second conductive layer is deposited either by sputtering or e-beam evaporation process. And then the second conductive metal layer is defined by a third photolithography to form the top electrodes 690 for the capacitors, and an interconnection circuit to connect the resistor 660, the capacitors and the mounting pads 700 for LED chip.

In the FIG. 6 (e), the micromachined ESD protection device is passivated by deposited a layer of PECVD low stress silicon nitride 720 with a thickness of 3000 A to 4000 A. The passivation layer 720 is applied to prevent the polyimide layer 680 from absorbing moisture which can significantly reduce its breakdown strength.

And subsequently in the FIG. 6 (f), a fourth photolithography and a drying etching process is performed to open the window for the mounting pads 700 on the interconnection circuit for LED chip.

What is claimed is:

1. An ESD protection device with high breakdown voltage for light emitting diodes (LED) comprising:
an insulation substrate;
a first capacitor formed on the substrate with a polyimide layer as its dielectric layer between its top and bottom electrode;
a resistor formed by a thin film metal layer on the substrate;
a second capacitor formed with the polyimide layer as its dielectric layer between its top and bottom electrode; and
wherein the resistor is serially connected between the first capacitor and the second capacitor to form the ESD protection device;
wherein the ESD protection device is passivated by silicon nitride to protect the polyimide layer from absorbing moisture since moisture can lower down the breakdown voltage of the polyimide layer; and
wherein the ESD protection device is connected to a LED chip in parallel to absorb and eliminate any unwanted voltage spike or electro static charges to the LED chip.

2. The ESD protection device with high breakdown voltage for light emitting diodes (LED) of claim 1 wherein
the substrate could be nonconductive materials selected from one of these materials: Alumina, aluminum nitride, quartz.

3. The ESD protection device with high breakdown voltage for light emitting diodes (LED) of claim 1 wherein
the substrate could be conductive materials with an insulation layer on top of its surface.

4. The ESD protection device with high breakdown voltage for light emitting diodes (LED) of claim 1 wherein
the first capacitor and second capacitor are identical; therefore the LED chip can be protected from the voltage spike or electro static charges coming from either polarity due to a symmetrical arrangement of the two capacitors in the ESD protection device.

5. The ESD protection device with high breakdown voltage for light emitting diodes (LED) of claim 1 wherein
the resistor and the capacitors are disposed on top surface of the substrate.

6. The ESD protection device with high breakdown voltage for light emitting diodes (LED) of claim 1 wherein
the LED chip is in parallel connected to the ESD protection device through connecting pads disposed on the top surface of the substrate.

7. The ESD protection device with high breakdown voltage for light emitting diodes (LED) of claim 1 wherein
the polyimide's thickness is ranged from 3 to 100 um.

8. The ESD protection device with high breakdown voltage for light emitting diodes (LED) of claim 1 wherein
the ESD protection device can form an array to provide a multiple usage functionality by connecting 2 or 3 of the ESD protection devices in parallel to the LED chip; therefore once one of the ESD protection devices in the array is damaged; the other ESD protection device in the array can still provide protection functionality.

9. The ESD protection device with high breakdown voltage for light emitting diodes (LED) of claim 1 wherein
the ESD protection device comprising steps of fabrication:
(a) providing an insulation substrate;
(b) forming a first conductive metal layer on the insulation substrate either by sputtering or e-beam evaporation process;
(c) defining the conductive metal layer by a first photolithography and etch process to form the resistor, and bottom electrodes for the first capacitor and the second capacitor;
(d) forming the polyimide layer as a dielectric film between the top and the bottom electrodes for the capacitors;
(e) a thick layer of photoresist is applied in a second photolithography and an oxygen plasma etch is performed to pattern the polyimide layer;
(f) forming a second metal conductive layer either by sputtering or e-beam evaporation process and then defining the second metal conductive layer by a third photolithography to form the top electrodes for the capacitors and an interconnection circuit to connect the resistor, the capacitors and the mounting pads for LED chip;
(g) a low stress silicon nitride layer is deposited by a plasma enhanced chemical vapor deposition to protect the polyimide layer from absorbing moisture which is coming from ambient environment;
(h) a fourth photolithography and etching process is applied to open the mounting pads on the interconnection circuit for LED chip.
